(19) United States
(12) Patent Application Publication
(10) Pub. No.: US 2012/0074910 A1
(43) Pub. Date: Mar. 29, 2012

(54) BATTERY CHARGE MANAGEMENT

(76) Inventor: Jose P. Piccolotto, Cordoba (AR)

(21) Appl. No.: 12/889,768

(22) Filed: Sep. 24, 2010

(51) Int. Cl. H02J 7/04; G01N 27/27

(52) U.S. Cl. 320/134; 324/426; 320/162

(57) ABSTRACT

An electronic device comprises at least one battery coupled to the electronic device by a switchable electrical connection and logic to place the battery charge level within a predetermined charge range and to disconnect the battery from the electronic device when the battery is within the predetermined charge range. Other embodiments may be described.

### RELATED APPLICATIONS

None.

### BACKGROUND

The subject matter described herein relates generally to the field of electronic devices and more particularly to battery charge management in electronic devices.

Many electronic devices such as notebook and laptop computers, personal digital assistants (PDAs), mobile telephones, and the like draw power from one or more batteries when the device(s) are not connected to an external power source. When the device(s) are plugged into an external power source, e.g., an alternating current (AC) power supply, the battery or batteries are charged, typically to a fully-charged state.

The life span of some battery constructions may be extended by storing the battery at an ideal charge level that may be less than a fully-charged state. Accordingly, techniques to manage the charge level of batteries may find utility.

### BRIEF DESCRIPTION OF THE DRAWINGS

The detailed description is described with reference to the accompanying figures.

FIG. 1 is a schematic illustration of an exemplary electronic device which may be adapted to implement battery charge management in accordance with some embodiments.

FIG. 2 is a schematic illustration of an exemplary connection between a battery and an electronic device in accordance with some embodiments.

FIG. 3 is flow diagram illustrating operations in a method to implement battery charge management in an electronic device, in accordance with some embodiments.

FIG. 4 is a schematic illustration of a system which may be adapted to implement thermal management, according to an embodiment.

### DETAILED DESCRIPTION

Described herein are exemplary systems and methods for battery charge management in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

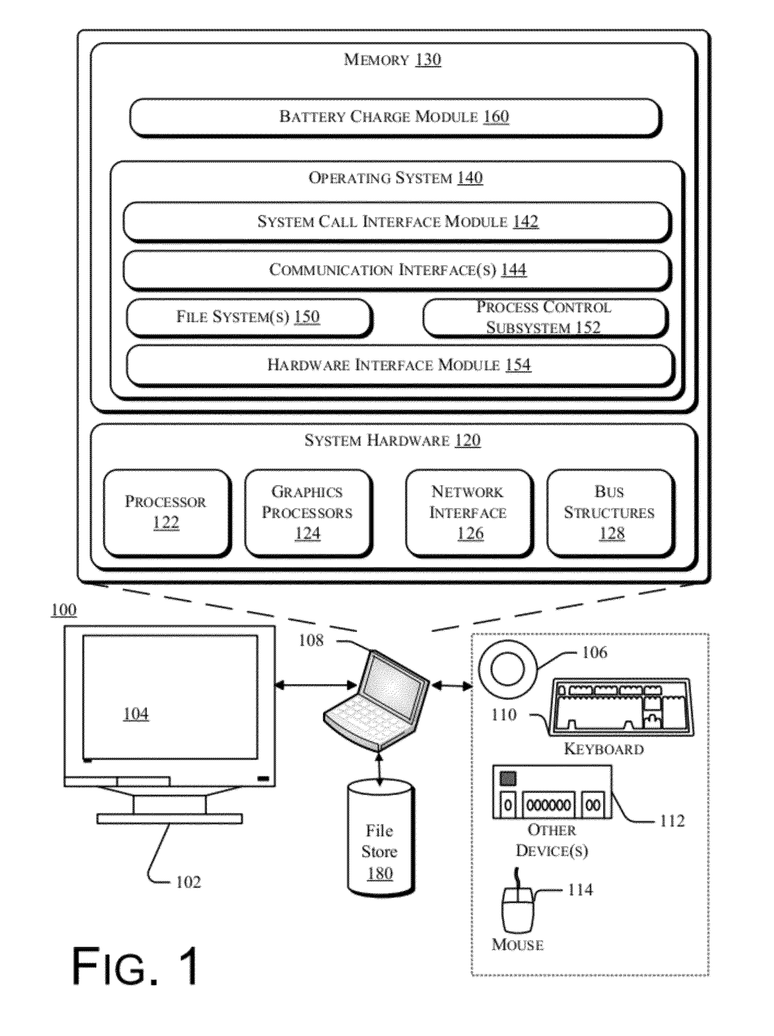

FIG. 1 is a schematic illustration of an exemplary system which may be adapted to implement battery charge management in accordance with some embodiments. In one embodiment, system 100 includes an electronic device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, and any other device that allows the system 100 to receive input from a user.

In various embodiments, the electronic device 108 may be embodied as a personal computer, a laptop computer, a personal digital assistant, a mobile telephone, an entertainment device, or another computing device.

The electronic device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, at least two graphics processors 124, network interfaces 126, and bus structures 128. In one embodiment, processor 122 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a Windows® brand operating system, or other operating systems.

As described above, battery charge management remains an issue in electronic device such as, e.g., electronic devices 108. Accordingly, in some embodiments the electronic device 108 may comprise a battery charge management module 160 which implements various techniques for battery charge management in such electronic devices are described herein. The battery charge management module 160 may be implemented as logic instructions stored in a computer-readable medium and executable on processor 122. Alternatively, the battery charge management module 160 may be implemented as logic encoded in configurable circuitry, e.g., a field programmable gate array (FPGA), or may be hardwired into circuitry such as a application specific integrated circuit (ASIC), or as a component of a larger integrated circuit.

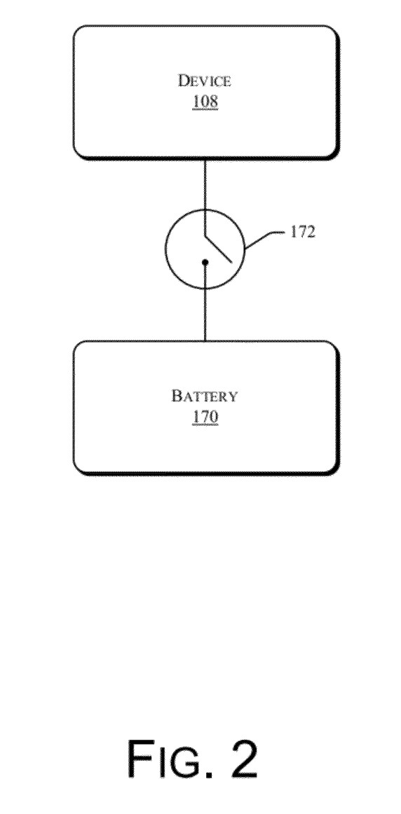

Referring to FIG. 2, in some embodiments an electronic device 108 is provided with a battery 170 that may be electrically connected to the electronic device 108 by a switchable electrical connection 172. The battery 170 may be implemented as a lithium-ion battery, nickel-metal-hydride battery, or the like. The switchable electrical connection may be implemented by a type of electrical switch capable of disconnecting the electrical connection between the battery 170 and the device 108.

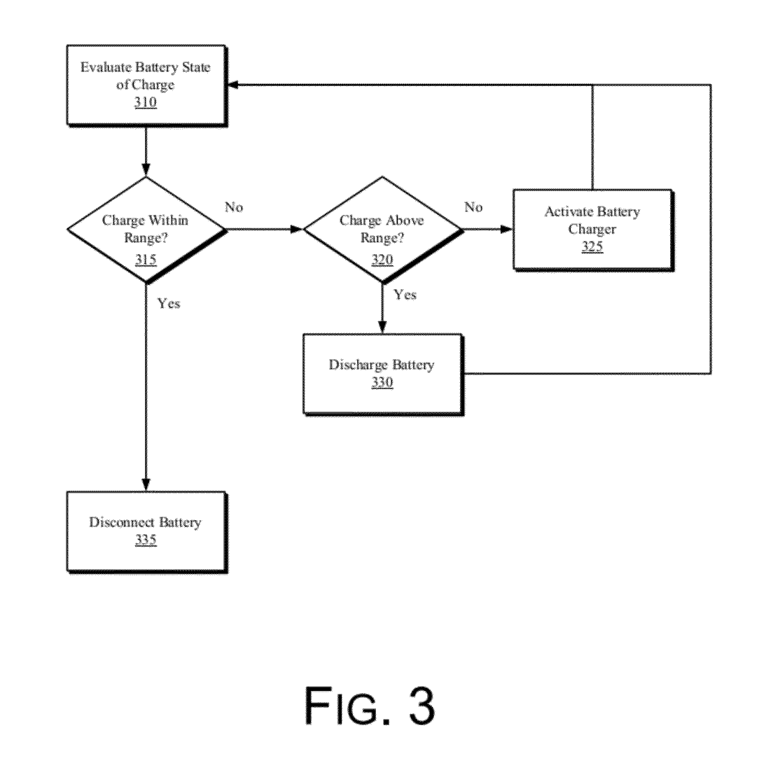

FIG. 3 is flow diagram illustrating operations in a method to implement battery charge management in an electronic device, in accordance with some embodiments. In some embodiments the method depicted in FIG. 3 may be implemented by the battery charge management module 160. The operations depicted in FIG. 3 may be initiated automatically by the battery charge management module 160, e.g., when the device is without intervention for a configurable predetermined period of time. Alternatively, operations of FIG. 3 or in response to an input from a user interface, e.g., a graphical user interface (GUI) on the device, or in response to a keystroke or series of keystrokes. In general, the method of FIG. 3 serves to place the battery at a charge level that is within a predetermined range of charge levels. The predetermined range of charge levels may be specific to the battery chemistry. In some embodiments the predetermined charge level is less than a fully-charged state. For example, lithium-ion batteries may be set to a charge level between 30% and 50%, and preferably to a charge level that is between 35% and 45%, with 40% as a target charge level. Referring now to FIG. 3, at operation 310 the battery state of charge is evaluated. In some embodiments the battery charge module 160 may determine the battery state of charge directly. In other embodiments the electronic device may comprise a separate battery charge monitoring unit, and the battery charge module may query the separate battery charge monitoring unit to discover the state of battery charge.

At operation 315 it is determined whether the battery state of charge is within a predetermined range. By way of example, for a lithium-ion battery a predetermined range may target a 40% charge level with a margin of error of plus or minus 5% to 10%, depending upon the level of precision desired. If, at operation 315, the battery state of charge is within the predetermined range, then control passes to operation 335 and the battery may be disconnected. By way of example, the battery may be disconnected at the switchable electrical connection 172.

By contrast, if at operation 315 the battery is not within the predetermined range then control passes to operation 320. If, at operation 320, it is determined that the battery state of charge is not above the upper charge level of the charge range, which means that the battery must be below the lower limit of the charge range, then control passes to operation 325 and a battery charge module is activated to charge the battery. Control then passes back to operation 310 and the battery state of charge is evaluated. In this regard, operations 310-325 define a loop by which the battery may be charged until the state of charge falls within the predetermined range, at which point the battery may be physically disconnected in operation 335.

If, at operation 320, the charge level of the battery is above the upper charge level of the predetermine range, then control passes to operation 330 and the battery is discharged. In some embodiments the battery may be discharged by implementing one or more power-intensive operations on the electronic device. By way of example, an not limitation, such operations may include spinning a hard disk drive on the device, defragmenting a hard disk drive, scanning a hard disk drive for security risks, backing up one or more files on a hard disk drive, or applying full power to a display module on the device or coupled to the device. When one or more battery discharge operations have been activated control passes back to operation 310 and the battery state of charge is evaluated. In this regard, operations 310-320 and 330 define a loop by which the battery may be discharged until the state of charge falls within the predetermined range, at which point the battery may be disconnected in operation 335.

Thus, the method depicted in FIG. 3 enables an electronic device to place a battery in a state of charge that falls within a predetermined range of charge states. The battery may then be physically disconnected from the electronic device to block parasitic energy consumption by the device, which eliminates, or at least reduces, leaks from the battery and reduces the stress of being charged all the time.

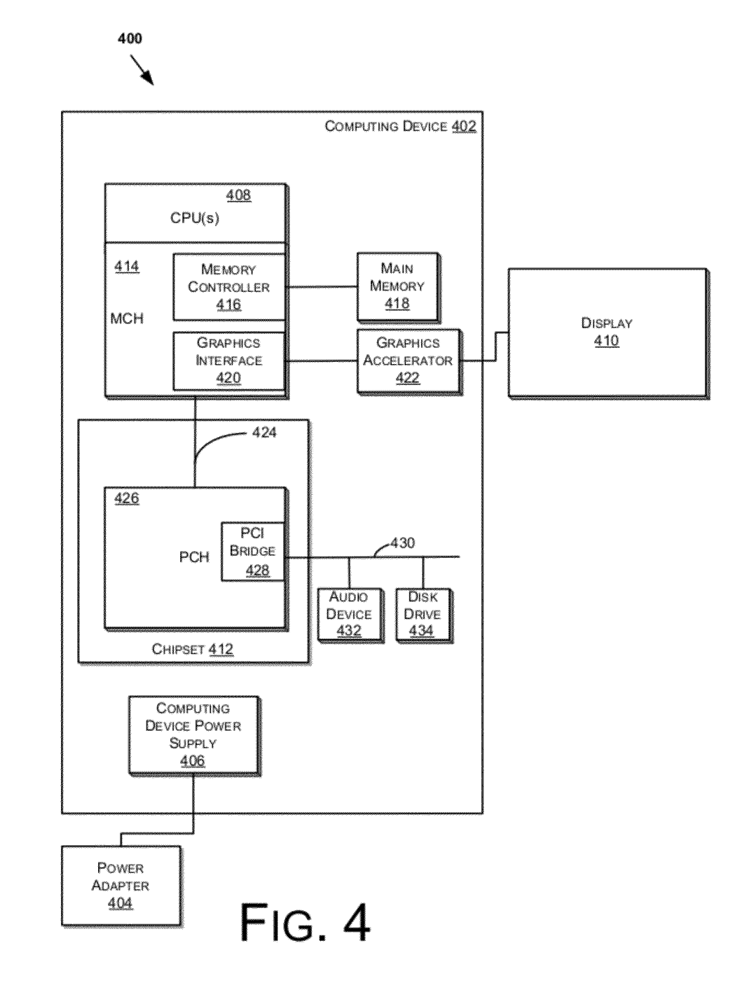

FIG. 4 is a schematic illustration of a computer system 400 in accordance with some embodiments. The computer system 400 includes a computing device 402 and a power adapter 404 (e.g., to supply electrical power to the computing device 402). The computing device 402 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 402 (e.g., through a computing device power supply 406) from one or more of the following sources: one or more battery packs, an alternating current (AC) outlet (e.g., through a transformer and/or adaptor such as a power adapter 404), automotive power supplies, airplane power supplies, and the like. In some embodiments, the power adapter 404 may transform the power supply source output (e.g., the AC outlet voltage of about 110 VAC to 240 VAC) to a direct current (DC) voltage ranging between about 4 VDC to 12.6 VDC. Accordingly, the power adapter 404 may be an AC/DC adapter.

The computing device 402 may also include one or more central processing unit(s) (CPUs) 408. In some embodiments, the CPU 408 may be one or more processors in the Pentium® family of processors including the Pentium® II processor family, Pentium® III processors, Pentium® IV, or CORE2 Duo processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 412 may be coupled to, or integrated with, CPU 408. The chipset 412 may include a memory control hub (MCH) 414. The MCH 414 may include a memory controller 416 that is coupled to a main system memory 418. The main system memory 418 stores data and sequences of instructions that are executed by the CPU 408, or any other device included in the system 400. In some embodiments, the main system memory 418 includes random access memory (RAM); however, the main system memory 418 may be implemented using other memory types such as dynamic RAM (DRAM), synchronous DRAM (SDRAM), and the like. Additional devices may also be coupled to the bus 410, such as multiple CPUs and/or multiple system memories.

The MCH 414 may also include a graphics interface 420 coupled to a graphics accelerator 422. In some embodiments, the graphics interface 420 is coupled to the graphics accelerator 422 via an accelerated graphics port (AGP). In some embodiments, a display (such as a flat panel display) 440 may be coupled to the graphics interface 420 through, for example, a signal converter that translates a digital representation of an image stored in a storage device such as video memory or system memory into display signals that are interpreted and displayed by the display. The display 440 signals produced by the display device may pass through various control devices before being interpreted by and subsequently displayed on the display.

A hub interface 424 couples the MCH 414 to a platform control hub (PCH) 426. The PCH 426 provides an interface to input/output (I/O) devices coupled to the computer system 400. The PCH 426 may be coupled to a peripheral component interconnect (PCI) bus. Hence, the PCH 426 includes a PCI bridge 428 that provides an interface to a PCI bus 430. The PCI bridge 428 provides a data path between the CPU 408 and peripheral devices. Additionally, other types of I/O interconnect topologies may be utilized such as the PCI Express™ architecture, available through Intel® Corporation of Santa Clara, Calif.

The PCI bus 430 may be coupled to an audio device 432 and one or more disk drive(s) 434. Other devices may be coupled to the PCI bus 430. In addition, the CPU 408 and the MCH 414 may be combined to form a single chip. Furthermore, the graphics accelerator 422 may be included within the MCH 414 in other embodiments.

Additionally, other peripherals coupled to the PCH 426 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 402 may include volatile and/or nonvolatile memory.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
an electronic device;
at least one battery coupled to the electronic device by a switchable electrical connection; and
logic to place the battery charge level within a predetermined charge range and to disconnect the battery from the electronic device when the battery is within the predetermined charge range.

2. The apparatus of claim 1, wherein the battery comprises a lithium-ion battery and the predetermined charge range is between a lower charge level of 30% and an upper charge level of 50%.

3. The apparatus of claim 1, wherein the battery comprises a lithium-ion battery and the predetermined charge range is between a lower charge level of 35% and an upper charge level of 45%.

4. The apparatus of claim 1, wherein the logic to place the battery charge level within a predetermined charge range comprises logic to:
determine a current charge level of the battery; and
charge the battery to a charge level that is above a lower charge level.

5. The apparatus of claim 1, wherein the logic to place the battery charge level within a predetermined charge range comprises logic to:
determine a current charge level of the battery; and
discharge the battery to a charge level that is below an upper charge level.

6. The apparatus of claim 5, further comprising logic to implement at least one power consuming operation on the electronic device.

7. The apparatus of claim 6, wherein the at least one power consuming operation comprises at least one of:
spinning a hard disk drive;
defragmenting a hard disk drive;
scanning a hard disk drive for security risks;
backing up one or more files on a hard disk drive; or
applying full power to a display.

8. A method, comprising:
placing a battery coupled to an electronic device at a battery charge level within a predetermined charge range; and
disconnecting the battery from the electronic device when the batter is within the predetermined charge range.

9. The method of claim 8, wherein the battery comprises a lithium-ion battery and the predetermined charge range is between a lower charge level of 30% and an upper charge level of 50%.

10. The method of claim 8, wherein the battery comprises a lithium-ion battery and the predetermined charge range is between a lower charge level of 35% and an upper charge level of 45%.

11. The method of claim 8, wherein placing the battery charge level within a predetermined charge rate comprises:
determining a current charge level of the battery; and
charging the battery to a charge level that is above a lower charge level.

12. The method of claim 8, wherein placing the battery charge level within a predetermined charge rate comprises:
determining a current charge level of the battery; and
discharging the battery to a charge level that is below an upper charge level.

13. The method of claim 12, further comprising implementing at least one power consuming operation on the electronic device.

14. The method of claim 13, wherein the at least one power consuming operation comprises at least one of:
spinning a hard disk drive;
defragmenting a hard disk drive;
scanning a hard disk drive for security risks;
backing up one or more files on a hard disk drive; or
applying full power to a display.

15. A battery charge management module which may be used in an electronic device, comprising:
logic to place the battery charge level within a predetermined charge range and to disconnect the battery from the electronic device when the battery is within the predetermined charge range.

16. The battery charge management module of claim 15, wherein the battery comprises a lithium-ion battery and the predetermined charge range is between a lower charge level of 30% and an upper charge level of 50%.

17. The battery charge management module of claim 15, wherein the logic to place the battery charge level within a predetermined charge rate comprises logic to:
determine a current charge level of the battery; and
charge the battery to a charge level that is above a lower charge level.

18. The battery charge management module of claim 15, wherein the logic to place the battery charge level within a predetermined charge rate comprises logic to:
determine a current charge level of the battery; and
discharge the battery to a charge level that is below an upper charge level.

19. The battery charge management module of claim 18, further comprising logic to implement at least one power consuming operation on the electronic device.

20. The battery charge management module of claim 19, wherein the at least one power consuming operation comprises at least one of:
spinning a hard disk drive;
defragmenting a hard disk drive;
scanning a hard disk drive for security risks;
backing up one or more files on a hard disk drive; or
applying full power to a display.
